(19) United States
(12) Patent Application Publication
(10) Pub. No.: US 2026/0116113 A1
(43) Pub. Date: Apr. 30, 2026

(54) THERMAL RECORDING MATERIAL

(71) Applicant: OSAKA SEALING PRINTING CO., LTD., Osaka (JP)

(72) Inventors: Miwa Moriya, Osaka (JP); Yusuke Egashira, Osaka (JP)

(73) Assignee: OSAKA SEALING PRINTING CO., LTD., Osaka (JP)

(21) Appl. No.: 19/148,109

(22) PCT Filed: Nov. 30, 2023
(86) PCT No.: PCT/JP2023/042993

§ 371 Date: Jul. 15, 2025

(30) Foreign Application Priority Data
Jan. 16, 2023 (JP) 2023-004351

(51) Int. Cl. B41M 5/36

(52) U.S. Cl. CPC B41M 5/36

(57) ABSTRACT

The present invention aims to provide a thermal recording material with satisfactory transparency and the curling suppressed. The thermal recording material is a thermal recording material 1, wherein a substrate 2, a thermal recording layer 3 and a protective layer 4 are stacked on one surface of the substrate 2 in this order, and a back coat layer 5 is formed on the other surface of the substrate 2. The substrate 2 consists of a transparent resin film, and the back coat layer 5 comprises a core-shell type resin and polyamide-epichlorohydrin resin. It is preferable that the protective layer 4 include a top coat layer 6 and an intermediate layer 7 between the top coat layer 6 and the thermal recording layer 3.

### TECHNICAL FIELD

The present invention relates to a thermal recording material.

### BACKGROUND ART

Thermal recording materials are heated by thermal heads, resulting in color development to obtain recorded images. Thermal recording materials are used for a wide variety of applications of facsimiles, automatic ticket vending machines, output printers of scientific measuring instruments, and CRT medical measuring instruments.

If such thermal recording materials are used, for example, as labels or packaging films for containers storing various foods, the labels or the packaging films hide the contents of the containers, so that it makes difficult for consumers to check the contents.

Accordingly, the present applicant has formed a thermal recording material for producing transparent labels or packaging films. That is, the present applicant has proposed a highly transparent thermal recording material for producing transparent labels and packaging films so that the contents of the containers can be checked (for example, refer to Patent Literature 1).

### CITATION LIST

### Patent Literature

Patent Literature 1: Japanese Patent No. 6202599

### SUMMARY OF INVENTION

### Technical Problem

A problem of waste plastics has become serious recently, resulting in an emphasis on plastic reduction as environmental countermeasures, so that a decrease in the amount of plastics used has been desired.

It is therefore desired that a substrate film be thinned also in the thermal recording material proposed in the above-mentioned Patent Literature 1 for reducing the amount of plastic used.

If a substrate film is thinned, a thermal recording layer or others formed on the substrate film however have a stronger influence on stress. Disadvantageously, the thermal recording material therefore curls to the printed surface side on which the thermal recording layer is formed.

The present inventors have noticed such a situation to complete the present invention, which is directed to providing a thermal recording material with satisfactory transparency and the curling thereof is suppressed.

### Solution to Problem

In order to achieve the above-mentioned object, the present invention is configured as follows.

(1) A thermal recording material of the present invention is a thermal recording material wherein a substrate, a thermal recording layer and a protective layer are stacked on one surface of the substrate in this order, and a back coat layer is formed on the other surface of the above-mentioned substrate, wherein the above-mentioned substrate consists of a transparent resin film, and wherein the above-mentioned back coat layer contains a core-shell type resin and polyamide-epichlorohydrin resin.

According to the thermal recording material of the present invention, the back coat layer contains the core-shell type resin, therefore has satisfactory film formability as compared with general-purpose emulsions. A general-purpose emulsion are generally particles, which are fused into a film after drying. Meanwhile, it is conceivable that since the shells having water-soluble moieties are partially dissolved before drying, and are not particles, the film formability of the core-shell type resin further improved. Even though the thermal recording layer and the protective layer are stacked, the back coat layer can therefore withstand stress caused thereby to consequently suppress the curl. Since the above-mentioned back coat layer contains the polyamide-epichlorohydrin resin as a crosslinking agent for crosslinking the core-shell type resin, the transparency is improved as compared with oxazoline-based crosslinking agents as described below.

(2) In a preferable embodiment of the present invention, the above-mentioned protective layer includes a top coat layer and an intermediate layer formed between the top coat layer and the above-mentioned thermal recording layer.

According to this embodiment, the protective layer includes the top coat layer to enable improving the matching properties of the thermal recording layer to the thermal head, resulting in appropriate color development in the thermal recording layer.

The protective layer includes the intermediate layer to enable imparting barrier properties to water and oil.

(3) In another embodiment of the present invention, the above-mentioned intermediate layer contains a core-shell type resin and polyamide-epichlorohydrin resin.

According to this embodiment, the intermediate layer contains the core-shell type resin having water-soluble moieties. Coating liquid for forming the intermediate layer is applied to the thermal recording layer and dried, so that the core-shell type resin having the water-soluble moieties therefore permeates the thermal recording layer to form a smooth intermediate layer. This suppresses irregular reflection of light on the thermal recording layer, and improves the transparency of the thermal recording material.

The core-shell type resin and the polyamide-epichlorohydrin resin as the crosslinking agent are used for the intermediate layer which is a protective layer on the one surface side of the substrate and the back coat layer on the other surface side of the substrate. Stresses on the one surface side and the other surface side of the substrate therefore cancel each other, so that the curl can be suppressed effectively.

(4) In yet another embodiment of the present invention, the above-mentioned coating liquid for forming the back coat layer has a dynamic surface tension of 51 mN/m or less at 50 msec.

According to this embodiment, the coating liquid for forming the back coat layer has a dynamic surface tension of 51 mN/m or less at 50 msec, so that the coating liquid has satisfactory coating suitability against the substrate. The coated surface therefore has even and uniform surface quality. Consequently, the transparency is uniformed, and stress are also obtained.

(5) In another embodiment of the present invention, the above-mentioned substrate has a thickness of not less than 10 μm and not more than 50 μm.

According to this embodiment, the transparent resin film as the substrate has a thin thickness of 50 μm or less, which therefore enables reducing the amount of the resin material used for plastic reduction.

### Advantageous Effects of Invention

According to the present invention, the back coat layer thus contains the core-shell type resin, and therefore has satisfactory film formability as compared with general-purpose emulsions. Even though the thermal recording layer and the protective layer are stacked, the back coat layer can therefore withstand stress caused thereby to consequently suppress the curl. Since the above-mentioned back coat layer contains the polyamide-epichlorohydrin resin as the crosslinking agent for crosslinking the core-shell type resin, the transparency is improved as compared with oxazoline-based crosslinking agents as described below.

### BRIEF DESCRIPTION OF DRAWING

FIG. 1 is a schematic cross-sectional view of a thermal recording material of an embodiment of the present invention.

### DESCRIPTION OF EMBODIMENTS

Hereinafter, embodiments of the present invention will be described in detail based on the drawing.

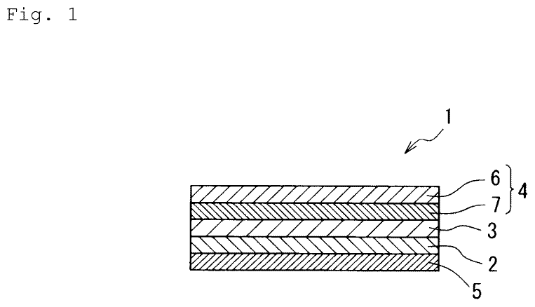

FIG. 1 is a schematic cross-sectional view of a thermal recording material of an embodiment of the present invention. In a thermal recording material 1 of this embodiment, a thermal recording layer 3, which develops color by heating, is stacked on the upper surface as one surface of a substrate 2, a protective layer 4 is stacked on the surface of the above-mentioned thermal recording layer 3, and a back coat layer 5 is formed on the lower surface as the other surface of the above-mentioned substrate 2. The protective layer 4 includes a top coat layer 6 constituting the surface layer and an intermediate layer 7 formed between this top coat layer 6 and the thermal recording layer 3.

Hereinafter, the configurations of the layers will be described.

### Substrate

Examples of the usable substrate 2 include transparent synthetic resin films such as a polypropylene film, a polyethylene terephthalate film, a polystyrene film, and a polycarbonate film. The above-mentioned substrate 2 may be single-layered or multiple-layered. The thickness of such film is not particularly limited. If the thickness is around 10 to 100 μm, the substrate 2 is high in coatability on the substrate 2 and transparency, so that the substrate 2 is preferable. In order to decrease the used amount of the resin material for plastic reduction, the substrate 2 has a thickness of preferably 50 μm or less, more preferably 40 μm or less.

### Thermal Recording Layer

A color former that develops a color by heating, a developer, a filler, a binder, and a lubricant are contained as materials forming the thermal recording layer 3.

It is preferable to use the materials having small particle diameters for improving the transparency of the thermal recording material 1. Such materials having small particle diameters enables suppressing irregular reflection of light and improving the transparency of the thermal recording material.

Specific examples of usable leuco dye as the color former include 3-(N-isobutyl-N-ethyl)amino-6-methyl-7-anilinofluoran, 3-(N-isopentyl-N-ethyl)amino-6-methyl-7-o-chloroanilinofluoran, 3-(N-ethyl-N-p-toluidino)-6-methyl-7-anilinofluoran, 3-(N-ethyl-N-isopentyl)amino-6-methyl-7-anilinofluoran, 3-(N-ethoxypropyl-N-ethyl)amino-6-methyl-7-anilinofluoran, 3-(N-cyclohexyl-N-methyl)amino-6-methyl-7-anilinofluoran, 3-(N-methyl-N-n-propyl)amino-6-methyl-7-anilinofluoran, 3-dibutylamino-6-methyl-7-anilinofluoran, 3-diethylamino-6-methyl-7-p-toluidinofluoran, 3-diethylamino-6-methyl-7-anilinofluoran, 3-diethylamino-6-methyl-8-methylfluoran, 3-diethylamino-7-(m-trifluoromethylanilino)fluoran, 3-diethylamino-7-(o-chloroanilino)fluoran, 3-diethylamino-7-chlorofluoran, 3-dibutylamino-6-methyl-7-bromofluoran, 3-dibutylamino-7-(o-chloroanilino)fluoran, 3-dipentylamino-6-methyl-7-anilinofluoran, 3-dimethylamino-5-methyl-7-methylfluoran, 3-pyrrolidino-6-methyl-7-anilinofluoran, and crystal violet lactone. These leuco dyes can be used alone or in combination of two or more.

It is preferable that the above-mentioned color former have a particle diameter of 0.1 μm to 1.0 μm. Here, the particle diameter refers to 50% average particle diameter measured with a Microtrac Laser Diffraction and Scattering Particle Size Analyzer. Hereinafter, “particle diameter” refers to 50% average particle diameter measured with a Microtrac Laser Diffraction and Scattering Particle Size Analyzer.

Examples of a usable developer include 1,1-bis(p-hydroxyphenyl)cyclohexane, 1,1-bis(p-hydroxyphenyl)propane, 2,2-bis(p-hydroxyphenyl)propane, 2,2-bis(p-hydroxyphenyl) butane, 1,1-bis(4-hydroxyphenyl)-1-phenylethane, 2,2′-methylenebis(4-chlorophenol), 2,2-bis(4-hydroxyphenyl)-4-methylpentane, 2,4′-dihydroxydiphenylsulfone, 4,4′-dihydroxydiphenylsulfone, 4-hydroxy-4′-n-propoxydiphenylsulfone, 4-hydroxy-4′-isopropoxydiphenylsulfone, 4-hydroxy-4′-methyldiphenylsulfone, 4-hydroxyphenyl-4′-benzyloxyphenylsulfone, 4-hydroxy-4′-allyloxydiphenylsulfone, bis(3-allyl-4-hydroxyphenyl)sulfone, poly(4-hydroxybenzoic acid), benzyl 4-hydroxybenzoate, 2,4-bis(phenylsulfonyl)phenol, α-{4-[(4-hydroxyphenyl)sulfonyl]phenyl}-ω-hydroxypoly (degree of polymerization: n=1 to 7) (oxyethyleneoxyethyleneoxy-p-phenylenesulfonyl-p-phenylene) 2,2-bis[(4-methyl-3-phenoxy carbonylaminophenyl)urea]diphenylsulfone, 3,5-bis(α-methylbenzyl)salicylic acid, bis[zinc 4-(n-octyloxycarbonylamino)salicylate], 4,4′-bis(p-tolylsulfonylaminocarbonylamino)diphenylmethane, 4-hydroxybenzenesulfonanilide, 2′-(3-phenylureide)benzenesulfonanilide, N-(2-hydroxyphenyl)-2-[(4-hydroxyphenyl)thio]acetamide, N-(4-hydroxyphenyl)-2-[(4-hydroxyphenyl)thio]acetamide, 4-[[4-[4-[4-[[4-(1-methylethoxy)phenyl]sulfonylphenoxy]butoxy]phenyl]sulfonyl]phenol, 4-tert-butylphenol-formaldehyde polycondensate, N-(p-toluenesulfonyl)-N′-(3-p-toluenesulfonyloxyphenyl)urea, and 1-phenyl-3-(4-methylphenylsulfonyl)urea. The particle diameters thereof are preferably not less than 0.1 μm and not more than 1.0 μm. These developers can be used alone or in combination of two or more.

Examples of the above-mentioned filler that is usable include aluminum hydroxide, magnesium hydroxide, aluminum oxide, magnesium oxide, aluminum silicate, calcium carbonate, magnesium carbonate, titanium oxide, barium sulfate, silica gel, activated clay, talc, clay, kaolin, fired kaolin, diatomaceous earth, white carbon, zinc oxide, silicon oxide, colloidal silica, polystyrene resin particles, urea-formalin resin particles, and polyolefin resin particles. The particle diameters thereof are preferably 1.0 μm or less. These fillers can be used alone or in combination of two or more.

Examples of the above-mentioned binder that is usable include polyvinyl alcohol, modified polyvinyl alcohol, starch, casein, gelatin, polyamide, polyacrylamide, modified polyacrylamide, hydroxyethylcellulose, methylcellulose, carboxymethylcellulose, hydroxypropylcellulose, polyvinyl acetate, polyacrylate ester, a styrene-maleic anhydride copolymer, an isobutylene-maleic anhydride copolymer, a diisobutylene-maleic anhydride copolymer, a vinyl acetate-maleic anhydride copolymer, a methylvinyl-maleic anhydride copolymer, an isopropylene-maleic anhydride copolymer, a styrene-butadiene copolymer, polyvinyl chloride, polyvinylidene chloride, a vinyl chloride-vinyl acetate copolymer, polyurethane, polystyrene, polyvinylpyrrolidone, acrylate ester, acrylonitrile, and methyl vinyl ether. These binders can be used alone or in combination of two or more.

Examples of the sensitizer that is usable include stearic acid, stearamide, stearanilide, methylolstearamide, methylene-bis-stearamide, ethylene-bis-stearamide, 1-benzyloxynaphthalene, 2-benzyloxynaphthalene, 2,6-diisopropylnaphthalene, 1,2-diphenoxyethane, 1,2-diphenoxymethylbenzene, 1,2-bis(3,4-dimethylphenol)ethane, 1,2-bis(3-methylphenoxy)ethane, 1,2-bis(4-methylphenoxy)ethane, di(p-chlorobenzyl) oxalate, di(p-methylbenzyl) oxalate, dibenzyl oxalate, p-benzylbiphenyl, m-terphenyl, diphenylsulfone, benzyl p-benzyloxybenzoate, dibenzyl terephthalate, and p-toluenesulfonamide. These sensitizers can be used alone or in combination of two or more.

Examples of the above-mentioned lubricant that is usable include paraffin wax; fatty acids such as oleic acid; polyolefin waxes such as polyethylene wax; metallic soaps such as zinc stearate; ester waxes such as carnauba wax; silicone oil; and oils such as whale oil. The particle diameters thereof are preferably 0.5 μm or less. These lubricants can be used alone or in combination of two or more.

It is known that it is particularly effective to incorporate paraffin wax into the thermal recording layer 3 for improving the transparency of the thermal recording material 1. This paraffin preferably has a low melting point less than the color developing temperature of the thermal recording layer 3, preferably less than 80° C., more preferably less than 50° C.

As mentioned above, it is preferable that the particle diameter of this low melting paraffin be 0.5 μm or less. It is preferable that the content of this paraffin be, for example, 0.1 g/m² to 1.0 g/m² in terms of dry weight.

If the low melting paraffin is thus incorporated, the coating liquid for forming thermal recording layer 3 is applied to the substrate 2, followed by the drying of the coating liquid, so that the low melting paraffin is molten to fill in the gaps such as recesses in the surfaces of particles constituting the thermal recording layer 3. This suppresses the irregular reflection of light on the thermal recording layer 3 to enable the transparency of the thermal recording material 1.

### Protective Layer

The protective layer 4 in this embodiment includes a top coat layer 6 and an intermediate layer 7.

The intermediate layer 7 has barrier properties to water and oil to improve the water resistance or the chemical resistance of the thermal recording layer 3. The top coat layer 6 improves the matching properties of the thermal recording layer 3 to the thermal head, resulting in appropriate color development in the thermal recording layer 3.

The intermediate layer 7 is formed mainly of resin. For example, the resin may have water-soluble moieties, or may not have water-soluble moieties. Specific examples include acrylic-based resins such as acrylic resin, styrene-acrylic resin, acrylic-urethane resin, acrylic-amide resin, and vinyl acetate-acrylic resin; epichlorohydrin-based resins such as polyamide-epichlorohydrin resin, polyamine-epichlorohydrin resin, and polyamide-polyamine-epichlorohydrin resin; maleic acid-based resins such as maleic acid resin, styrene-maleic acid resin, and olefin-maleic acid resin; styrene-butadiene resin (SBR); acrylonitrile-butadiene-styrene resin; vinyl acetate resin; and polyvinyl alcohol-based resins such as completely saponified polyvinyl alcohol resin, partially saponified polyvinyl alcohol resin, diacetone-modified polyvinyl alcohol resin, acetoacetyl-modified polyvinyl alcohol resin, sulfonic acid-modified polyvinyl alcohol resin, olefin-modified polyvinyl alcohol resin, nitrile-modified polyvinyl alcohol resin, pyrrolidone-modified polyvinyl alcohol resin, silanol-modified polyvinyl alcohol resin, and cation-modified polyvinyl alcohol resin. These resins may be modified by a known method. These resins can be used alone or in combination of two or more. Compositions for forming these resins may be solids, emulsions, or solutions. The compositions are preferably emulsions or solutions from the viewpoint of high coatability.

The “acrylic-based resin” as used herein means a resin obtained by polymerizing acrylic monomers (acrylic resin) or a resin obtained by copolymerizing acrylic monomers and other monomers (monomers other than acrylic monomers that are copolymerizable with the acrylic monomers). The above-mentioned other monomers may be of two or more types. The mere description “acrylic” means (meth)acrylic acid (salt) and/or (meth)acrylic ester unless otherwise specified. The “(meth)acrylic acid” as used herein means acrylic acid and/or methacrylic acid. The “(meth)acrylic acid (salt)” means a (meth)acrylic acid and/or a (meth)acrylic acid salt.

Examples of the above-mentioned (meth)acrylic acid salt include, but not particularly limited to, ammonium salts of ammonia etc.; alkanolamine salts of triethanolamine, diethanolamine, and monoethanolamine etc.; alkylamine salts such as methylamine salts, ethylamine salts, diethylamine salts, and triethylamine salts; polyamine salts such as diethyleneamine salts and diethylenetriamine salts; alkali metal salts of lithium, sodium, and potassium etc.; alkaline-earth metal salts of magnesium and calcium etc.; and polyvalent metal salts of zinc and iron etc. These salts can be used alone or in combination of two or more.

In order to improve the transparency of the thermal recording material 1, examples of the resin of intermediate layer 7 include the resin having the water-soluble moieties, for example polyvinyl alcohol (PVA), which is a resin having hydroxy groups as hydrophilic structural units, and resins having carboxy groups as hydrophilic structural units (carboxy group-containing resins). The “carboxy group-containing resin” herein means a resin containing carboxy groups in the structure of a polymer or a copolymer forming the resin. The carboxy groups in the carboxy group-containing resin may be free carboxy groups or acid anhydride groups (specifically dicarboxylic anhydride groups). Furthermore, the acid anhydride groups may be partially ring-opened to be carboxy groups. In the carboxy group-containing resin, some or all of the carboxy-groups may be neutralized with alkali. A resin having reactive structural units is preferable in order to efficiently form crosslinked structure with a crosslinking agent described below, leading to further improving the film formability. The “reactive structural units” as used in the present invention mean structural units that have reactivity and can form crosslinked structure with other materials. Representative examples thereof include a carboxy group, an azetidinium ring, and an oxazoline group.

The intermediate layer 7 of this embodiment preferably contains at least one selected from the group consisting of the carboxy group-containing resin and the epichlorohydrin-based resin as the above-mentioned resin. It is more preferable that the intermediate layer 7 contain the carboxy group-containing resin and the epichlorohydrin-based resin from the viewpoint of forming the crosslinked structure described below, further improving the film formability, and improving the transparency and the effect to suppress curling.

The above-mentioned carboxy group-containing resin is more preferably at least one selected from the group consisting of acrylic-based resin and maleic acid-based resin; more preferably acrylic-based resin. The above-mentioned acrylic-based resin is preferably at least one selected from the group consisting of acrylic resin, styrene-acrylic resin, acrylic-urethane resin, acrylic-amide resin, and vinyl acetate-acrylic resin. The above-mentioned acrylic resin is more preferably at least one selected from the group consisting of acrylic resin, styrene-acrylic resin, and acrylic-urethane resin. The above-mentioned acrylic resin is further preferably at least one selected from the group consisting of acrylic resin and styrene-acrylic resin.

The above-mentioned epichlorohydrin-based resin is preferably at least one selected from the group consisting of polyamide-epichlorohydrin resin, polyamine-epichlorohydrin resin, and polyamide-polyamine-epichlorohydrin resin. The above-mentioned epichlorohydrin-based resin is more preferably at least one selected from the group consisting of polyamide-epichlorohydrin resin and polyamide-polyamine-epichlorohydrin resin. The above-mentioned epichlorohydrin-based resin is further preferably polyamide-epichlorohydrin resin.

Alternatively, it is preferable from the viewpoint of further improving the transparency of the thermal recording material 1 and the effect to suppress curling that the above-mentioned resin of the intermediate layer 7 contain a resin having a core-shell structure in which hydrophobic core particles are coated with water-soluble shell polymers, namely a core-shell type resin. The above-mentioned core-shell type resin is not particularly limited. For example, a carboxy group-containing resin having core-shell structure (core-shell type carboxy group-containing resin) is preferable. It is conceivable that the above-mentioned core-shell type carboxy group-containing resin contains carboxy groups in at least the structure of the water-soluble shell polymer. In general, hydrophobic core particles and a water-soluble shell polymer are formed by a multistep polymerization reaction to obtain the core-shell type resin. Examples of the resins forming the core particles and the shell polymer include the same resins as described above. The description of the above-mentioned resins can therefore be applied to the resin in the core-shell type resin in its entirety.

Specifically, the above-mentioned core-shell type carboxy group-containing resin is preferably at least one selected from the group consisting of a core-shell type acrylic-based resin and a core-shell type maleic acid-based resin; more preferably a core-shell type acrylic-based resin. The above-mentioned core-shell type acrylic-based resin is preferably at least one selected from the group consisting of a core-shell type acrylic resin, a core-shell type styrene-acrylic resin, a core-shell type acrylic-urethane resin, a core-shell type acrylic-amide resin, and a core-shell type vinyl acetate-acrylic resin; more preferably at least one selected from the group consisting of a core-shell type acrylic resin, a core-shell type styrene-acrylic resin, and a core-shell type acrylic-urethane resin; further preferably at least one selected from the group consisting of a core-shell type acrylic resin and a core-shell type styrene-acrylic resin; particularly preferable a core-shell type acrylic resin. Examples of this core-shell type acrylic-based resin include commercially available resin named BARIASTAR (available from Mitsui Chemicals, Inc.). The above-mentioned epichlorohydrin-based resin is a resin not having a core-shell structure, namely a non-core-shell type resin.

Water-soluble polyvinyl alcohol and a core-shell type acrylic resin have satisfactory film formability. The resin having the water-soluble moieties therefore permeates the thermal recording layer 3 to form a smooth intermediate layer 7 upon applying coating liquid for forming the intermediate layer to the thermal recording layer 3, followed by the drying thereof. This suppresses irregular reflection of light on the thermal recording layer 3, and improves the transparency of the thermal recording layer 3.

If even a resin having water-soluble moieties has poor film formability, the resin does not enable to suppress curling fully. Meanwhile, the above-mentioned core-shell type resin has a structure in which the hydrophobic core particles are coated with the water-soluble shell polymer, and has satisfactory film formability as compared with general-purpose emulsions. A general-purpose emulsion commonly contains particles, which are fused into a film after drying. Meanwhile, it is conceivable that since the shells having water-soluble moieties are partially dissolved before drying, and are not particles, the film formability of the core-shell type resin is further improved. Even though the back coat layer is stacked, the intermediate layer 7 can therefore withstand stress caused thereby to consequently have an effect on the suppression of curl.

It is preferable that the intermediate layer 7 of this embodiment contain a crosslinking agent. Examples of the crosslinking agent include organic crosslinking agents such as cationic crosslinking agents and non-cationic crosslinking agents; and inorganic crosslinking agents such as zirconium carbonate. Examples of the above-mentioned cationic crosslinking agents include epichlorohydrin-based resins such as polyamide-epichlorohydrin resin, polyamine-epichlorohydrin resin, polyamide-polyamine-epichlorohydrin resin. Examples of the above-mentioned non-cationic crosslinking agents include oxazoline-based compounds such as oxazoline group-containing polymers. As the above-mentioned crosslinking agent, a cationic crosslinking agent is preferable, and an epichlorohydrin-based resin is more preferable. Preferable types of the epichlorohydrin-based resin are the same as mentioned above. These crosslinking agents can be used alone or in combination of two or more.

In general, the crosslinking agent has reactive structural units as described above. The reactive structural units in the crosslinking agent are reacted with reactive structural units in the other material(s) to form a crosslinked structure, resulting in further improvement of the film formability, which further enables improving the transparency and the effect to suppress curling. For example, if the crosslinking agent is an epichlorohydrin-based resin, azetidinium rings (AZRs) as a reactive structural unit in the epichlorohydrin-based resin are reacted with other materials (for example, carboxy groups in the above-mentioned carboxy group-containing resin) to form a crosslinked structure. Thus, it is preferable from the viewpoint of further improving the film formability that the intermediate layer 7 of this embodiment contain the carboxy group-containing resin and the epichlorohydrin-based resin. It is also preferable that the intermediate layer 7 contain the core-shell type resin and the epichlorohydrin-based resin. Furthermore, it is more preferable that the intermediate layer 7 contain the core-shell type carboxy group-containing resin and the epichlorohydrin-based resin. Preferable types of the above-mentioned carboxy group-containing resin, the above-mentioned core-shell type carboxy group-containing resin, and the above-mentioned epichlorohydrin-based resin are the same as the respective descriptions about the above-mentioned carboxy group-containing resin, the above-mentioned core-shell type carboxy group-containing resin, and the above-mentioned epichlorohydrin-based resin.

The content rate of the above-mentioned resin is preferably 50% by mass or more, more preferably 60% by mass or more, further preferably 70% by mass or more, further preferably 80% by mass or more, particularly preferably 90% by mass or more based on 100% by mass of the intermediate layer 7 in terms of dry mass. If the content rate is in the above-mentioned range, the film formability is more satisfactory, and the transparency and the effect of suppressing curl can be further improved.

The content rate of the above-mentioned core-shell type resin is preferably 50% by mass or more, more preferably 60% by mass or more, further preferably 70% by mass or more based on 100% by mass of the resin in the intermediate layer 7 in terms of dry mass. The content rate of the above-mentioned core-shell type resin is preferably 99% by mass or less, more preferably 95% by mass or less, further preferably 90% by mass or less based on 100% by mass of the resin in the intermediate layer 7 in terms of dry mass. If the content rate is in the above-mentioned range, the film formability is more satisfactory, and the transparency and the effect of suppressing curl can be further improved. It is preferable that the content rate of the above-mentioned core-shell type resin based on 100% by mass of the intermediate layer 7 in terms of dry mass be in the above-mentioned range.

The content rate of the above-mentioned crosslinking agent is preferably 3% by mass or more, more preferably 6% by mass or more, further preferably 10% by mass or more based on 100% by mass of the resin in the intermediate layer 7 in terms of dry mass. The content rate of the above-mentioned crosslinking agent is preferably 40% by mass or less, more preferably 30% by mass or less, further preferably 20% by mass or less based on 100% by mass of the resin in the intermediate layer 7 in terms of dry mass. If the content rate is in the above-mentioned range, the film formability is more satisfactory, and the transparency and the effect of suppressing curl can be further improved. It is preferable that the content rate of the above-mentioned crosslinking agent based on 100% by mass of the intermediate layer 7 in terms of dry mass be in the above-mentioned range.

The intermediate layer 7 may further contain other materials than the above-mentioned materials. Examples of the other materials include a wetting agent.

For example, the coating amount (dry mass) of the above-mentioned intermediate layer 7 is preferably 0.3 g/m² to 10 g/m², more preferably 0.5 g/m² to 5.0 g/m², further preferably 1.0 g/m² to 4.0 g/m².

In this embodiment, the intermediate layer 7 contains the core-shell type acrylic resin and the polyamide-epichlorohydrin resin as the crosslinking agent in the same way as the back coat layer 5. This will be described in detail below with reference to Examples.

The top coat layer 6 is used, containing, for example, a filler, a lubricant, and a crosslinking agent in a binder.

Examples of the resin as the above-mentioned binder include acrylic resin. The resins mentioned in the item of the intermediate layer 7 are also applicable as other resins. These resins can be used alone or in combination of two or more. Examples of the above-mentioned lubricant include polyethylene and zinc stearate. The lubricants mentioned in the item of the thermal recording layer 3 are also applicable as other lubricants. These lubricants can be used alone or in combination of two or more.

Examples of the above-mentioned crosslinking agent include zirconium carbonate. The crosslinking agents mentioned in the item of the intermediate layer 7 are also applicable as other crosslinking agents. These crosslinking agents can be used alone or in combination of two or more.

Examples of the above-mentioned filler include colloidal silica, calcium carbonate, polymethyl methacrylate (PMMA), and polystyrene (PS). The fillers mentioned in the item of the thermal recording layer 3 are also applicable as other fillers. These fillers can be used alone or in combination of two or more.

It is preferable that the particle diameter of these fillers be 1.0 μm or less. In order to improve the transparency, colloidal silica having a small particle diameter is preferable as the filler.

### Back Coat Layer

The back coat layer 5 on the non-printed surface side of the substrate 2 is formed mainly of resin, the non-printed surface being opposite to the thermal recording layer 3. The back coat layer 5 contains at least the core-shell type resin and the polyamide-epichlorohydrin resin. The above-mentioned polyamide-epichlorohydrin resin is a non-core-shell type resin.

All the contents described in the item of the intermediate layer 7 are applicable to the resin contained in the back coat layer 5 of this embodiment. The resin contained in the back coat layer 5 may have water-soluble moieties, or may not have water-soluble moieties. Above all, the resin having water-soluble moieties is preferable. As discussed above, examples of the resin having water-soluble moieties include polyvinyl alcohol, which enables improving the transparency, but is poor in water resistance, so that the back coat layer may be exfoliated under conditions of high humidity.

Since further improvement in water resistance of thermal recording material 1 enables enhancing the effect of suppressing curl, in this embodiment, the back coat layer 5 contains the core-shell type resin as the resin having water-soluble moieties. Preferable examples of the above-mentioned core-shell type resin include, but not particularly limited to, the core-shell type carboxy group-containing resin. Preferable types of the above-mentioned core-shell type carboxy group-containing resin are the same as mentioned in the item of the intermediate layer 7. That is, the above-mentioned core-shell type carboxy group-containing resin is preferably at least one selected from the group consisting of a core-shell type acrylic-based resin and a core-shell type maleic acid-based acid resin; more preferably a core-shell type acrylic-based resin. The above-mentioned core-shell type acrylic-based resin is preferably at least one selected from the group consisting of a core-shell type acrylic resin, a core-shell type styrene-acrylic resin, a core-shell type acrylic-urethane resin, a core-shell type acrylic-amide resin, and a core-shell type vinyl acetate-acrylic resin; more preferably at least one selected from the group consisting of a core-shell type acrylic resin, a core-shell type styrene-acrylic resin, and a core-shell type acrylic-urethane resin; further preferably at least one selected from the group consisting of a core-shell type acrylic resin and a core-shell type styrene-acrylic resin; particularly preferably a core-shell type acrylic resin.

Polyamide-epichlorohydrin resin is used as the crosslinking agent for crosslinking the core-shell type acrylic resin.

If even a resin having water-soluble moieties has poor film formability, the resin does not enable suppressing curl fully. Meanwhile, in the core-shell type acrylic resin, the hydrophobic core particles are coated with the water-soluble shell polymer, resulting in more satisfactory film formability than in general-purpose emulsions. Even though the thermal recording layer and the protective layer are stacked, the back coat layer 5 can therefore withstand stress caused thereby to consequently have an effect on the suppression of the curl. Since the back coat layer 5 contains the hydrophobic cores, the water resistance is not deteriorated.

Furthermore, the polyamide-epichlorohydrin resin is used as the crosslinking agent for crosslinking the core-shell type acrylic resin, so that, as shown in the below-described comparative test between transparencies, the use of the polyamide-epichlorohydrin resin improves the transparency as compared with the use of an oxazoline crosslinking agent.

The content rate of the above-mentioned resin is preferably 50% by mass or more, more preferably 60% by mass or more, further preferably 70% by mass or more, further preferably 80% by mass or more, particularly preferably 90% by mass or more based on 100% by mass of the back coat layer 5 in terms of dry mass. If the content rate is in the above-mentioned range, the film formability is satisfactory, and the transparency and the effect to suppress curling can be further improved.

The content rate of the above-mentioned core-shell type resin is preferably 50% by mass or more, more preferably 60% by mass or more, further preferably 70% by mass or more based on 100% by mass of the resin in the back coat layer 5 in terms of dry mass. The content rate of the above-mentioned core-shell type resin is preferably 99% by mass or less, more preferably 95% by mass or less, further preferably 90% by mass or less based on 100% by mass of the resin in the back coat layer 5 in terms of dry mass. If the content rate is in the above-mentioned range, the film formability is satisfactory, and the transparency and the effect to suppress curling can be further improved. The content rate of the above-mentioned core-shell type resin based on 100% by mass of the back coat layer 5 in terms of dry mass is preferably in the above-mentioned range.

The content rate of the above-mentioned crosslinking agent is preferably 3% by mass or more, more preferably 6% by mass or more, further preferably 10% by mass or more based on 100% by mass of the resin in the back coat layer 5 in terms of dry mass. The content rate of the above-mentioned crosslinking agent is preferably 40% by mass or less, more preferably 30% by mass or less, further preferably 20% by mass or less based on 100% by mass of the resin in the back coat layer 5 in terms of dry mass. If the content is in the above-mentioned range, the film formability is more satisfactory, and the transparency and the effect to suppress curling can be further improved. It is preferable that the content rate of the above-mentioned crosslinking agent based on 100% by mass of the back coat layer 5 in terms of dry mass be in the above-mentioned range.

The back coat layer 5 may further contain other materials than the above-mentioned materials. Examples of the other materials include a wetting agent, a filler, a lubricant and an antiseptic.

Examples of the above-mentioned wetting agent that is usable include nonionic surfactants, anionic surfactants, cationic surfactants, ampholytic surfactants, and fluorine-containing surfactants. These surfactants can be used alone or in combination of two or more.

Examples of the above-mentioned nonionic surfactant that is usable include acetylene glycol-based surfactant, polyoxyethylene alkyl ether, polyoxyethylene alkyl phenyl ether, polyoxyethylene alkyl ester, and polyoxyethylene sorbitan fatty acid ester.

Examples of the above-mentioned acetylene glycol-based surfactants include acetylene glycol and alkylene oxide adducts of acetylene glycol. Examples of the above-mentioned acetylene glycol include 2,4,7,9-tetramethyl-5-decyne-4,7-diol, 3,6-dimethyl-4-octyne-3,6-diol, 3,5-dimethyl-1-hexyne-3-diol, and 2,5,8,11-tetramethyl-6-dodecyne-5,8-diol.

Examples of the above-mentioned anionic surfactants that are usable include polyoxyethylene alkyl ether sulfuric acids or salts thereof, polyoxyethylene alkyl ether acetic acids or salts thereof, dodecylbenzene sulfonic acid or salts thereof, alkyl sulfuric acids or salt thereof, and alkane sulfonic acids or salts thereof.

Above all, the above-mentioned wetting agent is preferably a nonionic surfactant, more preferably an acetylene glycol-based surfactant, further preferably an alkylene oxide adduct of acetylene glycol.

The wettability or the like of the wetting agent can be commonly adjusted depending on the HLB value thereof. The wetting agent has an HLB value of preferably 4 or more, more preferably 6 or more, further preferably not less than 6 and not more than 16 from the viewpoint of further improving the coatability on the back coat layer 5.

The coating amount (dry mass) of the coating liquid for forming the back coat layer 5 is preferably 0.3 g/m² to 10 g/m², more preferably 0.5 g/m² to 5.0 g/m², further preferably 1.0 g/m² to 4.0 g/m².

In this embodiment, stress that can be generated on one surface is preferably more approximate to stress that can be generated on the opposite surface to the above-mentioned surface in view from the substrate that is a support from the viewpoint of further suppressing curling of the thermal recording material. Both of the back coat layer 5 and the intermediate layer 7 contain preferably core-shell type resins, more preferably similar core-shell type resins, further preferably the same core-shell type resin. It is preferable that both of the back coat layer 5 and the intermediate layer 7 contain polyamide-epichlorohydrin resin. It is preferable that the back coat layer 5 and the intermediate layer 7 contain similar core-shell type resins and polyamide-epichlorohydrin resin. It is more preferable that the back coat layer 5 and the intermediate layer 7 contain the same core-shell type resin and polyamide-epichlorohydrin resin. It is preferable that the back coat layer 5 and the intermediate layer 7 contain the core-shell type acrylic-based resin and the polyamide-epichlorohydrin resin. It is more preferable that the back coat layer 5 and the intermediate layer 7 contain the core-shell type acrylic resin and the polyamide-epichlorohydrin resin.

The term “similar” as used here means that the resins have common reactive structural units. For example, similar core-shell type resins mean resins having common reactive structural units such as carboxy groups derived from acrylic monomers.

The mass ratio of the core-shell type resin in the intermediate layer 7 to the core-shell type resin in the back coat layer 5 (content (dry mass) of the core-shell type resin in intermediate layer 7 per unit area/content (dry mass) of the core-shell type resin in back coat layer 5 per unit area) is preferably 0.2 to 4, more preferably 0.3 to 3, further preferably 0.5 to 2, particularly preferably 0.7 to 1.5. If the mass ratio is in the above-mentioned range, the stress that can be generated on the one surface is more approximate to the stress that can be generated on the opposite surface to the above-mentioned surface in view from the substrate, so that the effect of suppressing curl can be further improved.

The mass ratio of the polyamide-epichlorohydrin resin in the intermediate layer 7 to the polyamide-epichlorohydrin resin in the back coat layer 5 (content (dry mass) of polyamide-epichlorohydrin resin in intermediate layer 7 per unit area/content (dry mass) of polyamide-epichlorohydrin resin in back coat layer 5 per unit area) is preferably 0.2 to 4, more preferably 0.3 to 3, further preferably 0.5 to 2, particularly preferably 0.7 to 1.5. If the mass ratio is in the above-mentioned range, the stress that can be generated on the one surface is more approximate to the stress that can be generated on the opposite surface to the above-mentioned surface in view from the substrate, so that the effect to suppress curling can be further improved.

The ratio of the coating amount (dry mass) of the coating liquid for forming the intermediate layer 7 to the coating amount (dry mass) of the coating liquid for forming the back coat layer 5 (coating amount (dry mass) of coating liquid for forming intermediate layer 7 per unit area/coating amount (dry mass) of coating liquid for forming back coat layer 5 per unit area) is preferably 0.3 to 3, more preferably 0.5 to 2, further preferably 0.7 to 1.5. If the ratio is in the above-mentioned range, the stress that can be generated on the one surface is more approximate to the stress that can be generated on the opposite surface to the above-mentioned surface in view from the substrate, so that the effect to suppress curling can be further improved.

Upon a curl test on the thermal recording material 1 (stack having the back coat layer 5 and the top coat layer 6 as both end surfaces) in this embodiment by the method described in Examples, it is preferable that the curl height be 6 mm or less under at least one condition of the three conditions prescribed in (B), and the curl be 6 mm or less under at least one condition in the subsequent (C). It is more preferable that the curl be 6 mm or less under at least two conditions of the three conditions prescribed in (B), and the curl be 6 mm or less under at least two conditions in the subsequent (C). It is further preferable that the curl be 6 mm or less under all the conditions of the three conditions prescribed in (B), and the curl be 6 mm or less under all the conditions in the subsequent (C).

Regarding a stack of the back coat layer 5 and the substrate 2 comprised in the thermal recording material 1 in this embodiment, the haze value of the stack composed of the back coat layer 5 and the substrate 2 is preferably 7 or less, more preferably 6 or less, further preferably 5 or less when the haze value is measured in the method described in Examples.

Regarding a stack of the back coat layer 5 and the substrate 2 comprised in the thermal recording material 1 in this embodiment, when the test of water-resistant adhesion of ink in the method described in Examples was performed against a stack of the back coat layer 5 and the substrate 2, it is preferable that the ink be not removed after the immersion in water for 1 minute; it is more preferable that the ink be not removed after the immersion in water for 2 minutes; and it is further preferable that less than 50% of the ink is removed after the immersion in water for 5 minutes.

### EXAMPLES

Although the present invention will be then described based on specific examples in further detail, the following Examples do not limit the present invention in any way.

The present inventors blended a base resin, crosslinking agents, and wetting agents shown in the following Table 1 as shown in Blend Nos. 1 to 5 to prepare coating liquids for forming back coat layers. All the blends were prepared at a solid content of 18.5%.

TABLE 1

| | Base resin | Crosslinking agent | | Wetting agent | | |
|---|---|---|---|---|---|---|
| | Core-shell | | Oxazoline- | Acetylene glycol- | Acetylene glycol- | |
| | type | Polyamide- | based | based surfactant | based surfactant | |
| | acrylic | epichlorohydrin | crosslinking | having an HLB | having an HLB | |
| Blend No. | resin | resin | agent | value of 13 to 14 | value of 8 | Total |
| No. 1 | 100 | 18 | | 1.3 | | 119.3 |
| No. 2 | 100 | | 18 | 1.3 | | 119.3 |
| No. 3 | 100 | | | | | 100.0 |
| No. 4 | 100 | 18 | | | 0.16 | 118.2 |
| No. 5 | 100 | 18 | | | 0.32 | 118.3 |

Blend No. 1 was prepared by blending 18 parts of a polyamide-epichlorohydrin resin as a crosslinking agent, 1.3 parts of an acetylene glycol-based surfactant with an HLB value of 13 to 14 as a wetting agent, based on 100 parts of a core-shell type acrylic resin as a base resin in terms of weight ratio in dry condition.

The HLB (hydrophile-lipophile balance) is a value indicating the degree of the affinity of a surfactant to water and oil. If this HLB value is more than 7, the hydrophilicity is strong. If this HLB value is less than 7, the hydrophobicity (lipophilicity) is strong.

Blend No. 2 was prepared by blending 18 parts of an oxazoline-based crosslinking agent, specifically Oxazoline WS300 (available from in NIPPON SHOKUBAI CO., LTD.), 1.3 parts of an acetylene glycol-based surfactant with an HLB value of 13 to 14 as a wetting agent, based on 100 parts of a core-shell type acrylic resin as a base resin in terms of weight ratio (in dry condition).

Blend No. 3 consisted exclusively of 100 parts of the core-shell type acrylic resin as a base resin without any crosslinking agent or any wetting agent.

Blend No. 4 was prepared by blending 18 parts of the polyamide-epichlorohydrin resin as a crosslinking agent, 0.16 parts of an acetylene glycol-based surfactant with an HLB value of 8 as a wetting agent, based on 100 parts of a core-shell type acrylic resin as a base resin in terms of weight ratio (in dry condition).

Blend No. 5 was prepared by blending 18 parts of the polyamide-epichlorohydrin resin as the crosslinking agent, 0.32 parts of an acetylene glycol-based surfactant with an HLB value of 8 as a wetting agent, based on 100 parts of a core-shell type acrylic resin as a base resin in terms of weight ratio (in dry condition).

The present inventors suitably selected a coating liquid from the coating liquids for forming back coat layers of Blend Nos. 1 to 5 to produce samples. The curl, the transparency, the adhesion of ink, and the dynamic surface tension were tested.

Hereinafter, the tests will be described.

### <Curl Test>

The present inventors produced the thermal recording material of Examples, shown in the above-mentioned FIG. 1, and the thermal recording material of Comparative Examples, free from a back coat layer 5, to perform a comparative test of the curl of both thermal recording materials.

In Examples, a back coat layer 5 was formed from the coating layer for forming the back coat layer of Blend No. 1 in the above-mentioned Table 1.

Examples and Comparative Examples have the same configuration except for the presence or the absence of the back coat layer 5. That is, a configuration of a substrate 2, a thermal recording layer 3, an intermediate layer 7, and a top coat layer 6 of Examples and Comparative Examples are the same.

Hereinafter, this configuration of the substrate 2, the thermal recording layer 3, the intermediate layer 7, and the top coat layer 6 will be described specifically. The configuration is the same as described in the above-mentioned Patent Literature 1 (Japanese Patent No. 6202599) proposed by the present applicant previously.

Accordingly, the thermal recording material having a configuration free from the back coat layer 5 is highly transparent as same as the thermal recording material described in Patent Literature 1.

At first, as the substrate 2, a PET (polyethylene terephthalate) film having a thickness of 25 μm was used.

For the thermal recording layer, 3 3,3′-diallyl-4,4′-dihydroxydiphenyl sulfone having a particle diameter of 0.4 μm was used as a developer and kaolin having a particle diameter of 0.4 μm was used as a filler. As a binder, SBR having a glass transition temperature, Tg, of “−3° C.” was used. As a lubricant, paraffin having a melting point of 46° C. and a particle diameter of 0.2 μm was used. As a dye, 2-aniline-3-methyl-6-(N-methyl-p-toluidino)fluoran having a particle diameter of 0.5 μm was used.

The developer, the kaolin, the SBR, the paraffin, and the dye were set to 25 parts, 10 parts, 20 parts, 4 parts, 12 parts, respectively, in terms of weight ratio in dry condition, to give total of 74 parts.

Coating liquid for forming the thermal recording layer was prepared at this blending ratio. The coating liquid was applied to the above-mentioned PET film at a coating amount of 4.5 g/m² in terms of dry weight. The coating liquid was then dried to obtain a thermal recording layer 3.

For the intermediate layer 7, a core-shell type acrylic resin was used as a binder, polyamide-epichlorohydrin resin was used as a crosslinking agent, and an acetylene glycol-based surfactant having an HLB value of 13 to 14 was used as a wetting agent.

The core-shell type acrylic resin, the polyamide-epichlorohydrin resin, and the acetylene glycol-based surfactant having an HLB value of 13 to 14 were set to 100 parts, 18 parts, 1.3 parts, respectively, in terms of weight ratio in dry condition, to give total of 119.3 parts.

Coating liquid for the intermediate layer was prepared at this blending ratio. The coating liquid was applied to the above-mentioned thermal recording layer 3 at a coating amount of 2.0 g/m² in terms of dry weight. The coating liquid was then dried to form an intermediate layer 7.

For the top coat layer 6, polyethylene (PE) having a particle diameter of 0.12 μm and zinc stearate (St-Zn) having a particle diameter of 5.5 μm were used as lubricants. As a binder, acrylic resin was used. As the crosslinking agent, zirconium carbonate was used. As the filler, colloidal silica having a particle diameter of several nanometers and colloidal silica having a particle diameter of several dozen nanometers were used.

The polyethylene (PE), the zinc stearate (St-Zn), the acrylic resin, the zirconium carbonate, the colloidal silica having a particle diameter of several nanometers, and the colloidal silica having a particle diameter of several dozen nanometers were set to 10 parts, 5 parts, 50 parts, 5 parts, 15 parts, 30 parts, respectively, in terms of weight ratio in dry condition, to give total of 130 parts.

Coating liquid for the top coat layer was prepared at this blending ratio. The coating liquid was applied to the above-mentioned intermediate layer 7 at a coating amount of 1.5 g/m² in terms of dry weight. The coating liquid was then dried to form a top coat layer 6.

Such a method provided the thermal recording material of Comparative Examples, namely the highly transparent thermal recording material described in Patent Literature 1. This thermal recording material was cut to 70 mm in the machine direction×240 to 320 mm in the width-wise direction to produce samples of Comparative Examples.

A thermal recording layer 3, an intermediate layer 7, and a top coat layer 6 were formed on a substrate 2 in the same way as described above. The coating liquid for forming the back coat layer of Blend No. 1 was further applied to the lower surface of the substrate 2 at 2.0 g/m² in terms of dry weight and dried to form the back coat layer 5.

Thus, provided was the thermal recording material of Examples. This thermal recording material was cut to 70 mm in the machine direction×240 to 320 mm in the width-wise direction to produce samples of Examples.

The thus produced samples of Examples and Comparative Examples were subjected to a curl test. The following Table 2 shows conditions and the results of this curl test.

TABLE 2

| | | | | | State of curl of sample left |
|---|---|---|---|---|---|
| | | | Relative | State of curl | to stand at 23° C. and 50% |
| | Humidity | Temperature | humidity | under test | for 2 hours after test |
| Sample | condition | (° C.) | (%) | conditions | under test conditions |
| Examples | Humidity: | 30° C. | 35% | ∘ | ∘ |
| (Blend | low | | | | |
| No. 1) | Humidity: | 30° C. | 67% | ∘ | ∘ |
| | medium | | | | |
| | Humidity: | 30° C. | 98% | ∘ | ∘ |
| | high | | | | |
| Comparative | Humidity: | 30° C. | 35% | x | ∘ |
| Examples | low | | | | |
| | Humidity: | 30° C. | 67% | ∘ | ∘ |
| | medium | | | | |
| | Humidity: | 30° C. | 98% | ∘ | x |
| | high | | | | |

∘: 3 mm or less
Δ: more than 3 mm and not more than 6 mm
x: more than 6 mm

The curl test were performed as follows.
(A) Before the start of the test, the samples of Examples and Comparative Examples for the test were left to stand under conditions of a temperature of 23° C. and a relative humidity of 50% for 24 hours.
(B) The samples of Examples and Comparative Examples were then left to stand under the conditions shown in Table 2, namely at a temperature of 30 degrees and low, medium, and high humidities, specifically relative humidities of 35%, 67%, and 98%, for 24 hours, and the curling states of the samples were evaluated.
(C) The samples of Examples and Comparative Examples, the curling states of which were evaluated in the above-mentioned (B), were further left to stand under conditions of a temperature of 23° C. and a relative humidity of 50% as shown in Table 2 for two hours, and the curling states were evaluated.

Assuming that the curl height is the maximum uplift height of the sample edge in the evaluation of the curling states, the curl height that was 3 mm or less was rated as ◯, the curl height that was more than 3 mm and not more than 6 mm was rated as Δ, and the curl height that was more than 6 mm was rated as X.

All the samples of Examples, including the back coat layers 5, had curl heights of 3 mm or less and were rated as ◯ after the samples were left to stand under the conditions in the above-mentioned (B) for 24 hours.

After all the samples of Examples, including the back coat layers 5, were left to stand under the conditions in the above-mentioned (C) for 2 hours, the sample had curl heights of 3 mm or less, and were rated as ◯.

Meanwhile, after the sample of Comparative Examples, free from the back coat layer, was left to stand under the conditions of a temperature of 30 degrees and a relative humidity of 35% among the conditions in the above-mentioned (B) for 24 hours, the sample had a curl height of 7 mm or more, and was rated as X.

After the sample of Comparative Examples were further left to stand under the conditions in the above-mentioned (C) for 2 hours, the sample had a curl height of 7 mm or more, and was rated as X.

The sample of Comparative Examples, free from the back coat layer 5, had a curl height of 7 mm or more in some cases. Meanwhile, even though the sample of Examples, including the back coat layer 5, comprised a thin substrate such as a PET (polyethylene terephthalate) film having a thickness of 25 μm, the sample of Examples had a curl height of 3 mm or less and rated as ◯, and never had a curl height of more than 3 mm.

As mentioned above, in Examples, the back coat layer contains a core-shell type acrylic resin with water-soluble moieties in which the hydrophobic core particles are coated with the water-soluble shell polymer as a base resin, and therefore has satisfactory film formability, and enables to suppress forming of the curl.

Since the polyamide-epichlorohydrin resin is used as the crosslinking agent, barrier properties, water resistance, and film formability are excellent, and enables to suppress curling at high temperature and high humidity or due to variations in humidity.

### <Comparative Test Between Transparencies>

Among the coating liquids for forming the back coat layers in the above-mentioned Table 1, the coating liquids of Blend Nos. 1, 2, and 3 were applied to PET (polyethylene terephthalate) films having a thickness of 25 μm as substrates at 2.5 g/m² in terms of dry weight, followed by the drying thereof. The transparencies were evaluated. At this time, the transparency of only the substrate not coated with any coating liquid was also evaluated together.

The transparency was evaluated by the measurement of the haze in accordance with JIS K 7136.

The following Table 3 shows the results of the measurement.

TABLE 3

| Blend No. | HAZE % | T. T % | P. T % | DIF |
|---|---|---|---|---|
| No. 1 | 4.35 | 89.94 | 85.59 | 4.35 |
| No. 2 | 8.28 | 90.05 | 82.41 | 7.64 |
| No. 3 | 4.92 | 89.84 | 85.42 | 4.42 |
| Substrate | 3.48 | 89.40 | 86.29 | 3.11 |
| (uncoated) | | | | |

Table 3 shows the total light transmittance (T.T), the parallel light transmittance (P.T), and the diffuse (scattered) light component (DIF) for calculating the haze together.

$$HAZE ( \% ) = DIF / T . T \times 100 = ( T . T - P . T ) / T . T \times 100$$

As shown in this Table 3, the haze value was 4.35(%), which meant the transparency was the highest, in the sample coated with the coating liquid of Blend No. 1 for forming the back coat layer, namely the coating liquid for forming the back coat layer that is shown in the above-mentioned Table 1 and was a blend of the core-shell type acrylic resin as a base resin, the polyamide-epichlorohydrin resin as the crosslinking agent, and the acetylene glycol-based surfactant.

The haze value was 4.92(%), which meant the transparency was the second highest, in the sample coated with the coating liquid of Blend No. 3 for forming the back coat layer, namely the coating liquid for forming the back coat layer that is shown in above-mentioned Table 1, consisting exclusively of the core-shell type acrylic resin as a base resin, and free from both of a crosslinking agent and a surfactant.

Meanwhile, the haze value was 8.28(%) which was the highest, which meant the transparency was the lowest, in the sample coated with the coating liquid of Blend No. 2 for forming the back coat layer, namely the coating liquid for forming the back coat layer that is shown in above-mentioned Table 1 and was a blend of the core-shell type acrylic resin as a base resin, the oxazoline-based crosslinking agent and the acetylene glycol-based surfactant.

The haze value was 3.48(%) in only the substrate not coated with any coating liquid, namely the PET (polyethylene terephthalate) film.

The haze value, 4.35, of the sample of Blend No. 1, containing the polyamide-epichlorohydrin resin as the crosslinking agent, is thus lower than the haze value, 8.28(%), of the sample of Blend No. 2, containing the oxazoline-based crosslinking agent. The lower haze value indicates satisfactory transparency.

The haze value, 4.35, of Blend No. 1, containing the polyamide-epichlorohydrin resin as the crosslinking agent, is lower than the haze value, 4.92, of Blend No. 3, consisting exclusively of the core-shell type acrylic resin and not containing any crosslinking agent. The lower haze value indicates satisfactory transparency.

The sample coated with the coating liquid for forming the back coat layer of Blend No. 1, containing the core-shell type acrylic resin and the polyamide-epichlorohydrin resin as the crosslinking agent, thus had the lowest haze value and the most satisfactory transparency.

### <Test of Adhesion of Ink>

Among the coating liquids for forming the back coat layers in the above-mentioned Table 1, the coating liquids of Blend Nos. 1, 2, and 3 were applied to PET (polyethylene terephthalate) films as substrates at 2.0 g/m² in terms of dry weight. Rotogravure ink for front surface printing was printed on these coated surfaces to produce samples. Rotogravure ink of RIJING series from DIC Graphics Corporation, was used.

A test of adhesion of ink and a test of water-resistant adhesion of ink, involving immersion of the samples in water, were performed with respect to the adhesion of the ink.

In the test of adhesion of the ink, cellophane adhesive tape was put on the printed surface of the sample and peeled away at an angle of 180°, followed by determining whether the ink was removed or not, so that the sample from which the ink was not removed was rated as ◯.

In the test of water-resistant adhesion of the ink, samples were immersed in water and taken out one minute after, and water was slightly wiped off. Cellophane tape was put on the printed surfaces and peeled away at an angle of 180°, followed by determining whether the ink was removed or not, so that the sample from which the ink was not removed was rated as ◯, the sample from which around less than 50% of the ink was removed was rated as Δ, and the sample from which around 50% or more of the ink was removed was rated as X.

Samples were immersed in water and taken out two minutes after, and water was slightly wiped off. Cellophane tape was put on the printed surfaces and peeled away at an angle of 180°, followed by determining whether the ink was removed or not.

The samples were immersed in water and taken out five minutes after and ten minutes after, respectively, followed by determining whether the ink was removed or not in the same way.

That is, the samples were immersed in water for four different times, namely one minute, two minutes, five minutes, and ten minutes, in the test of water-resistant adhesion of the ink.

The following Table 4 shows the results of the tests.

TABLE 4

Water-resistant adhesion of ink

| | Adhesion | 1 | 2 | 5 | 10 |
|---|---|---|---|---|---|
| Blend | of | minute | minutes | minutes | minutes |
| No. | ink | after | after | after | after |
| No. 1 | ∘ | ∘ | ∘ | Δ | x |
| No. 2 | ∘ | ∘ | ∘ | Δ | x |
| No. 3 | ∘ | Δ | x | x | x |

∘: No ink was removed.
Δ: Less than 50% of ink was removed.
x: 50% or more of ink was removed.

In the test of the adhesion of the ink, the ink was not removed in any of the samples including the back coat layers formed from the coating liquids for forming the back coat layers of Blend Nos. 1, 2, and 3. The samples were rated as ◯.

The tests of water-resistant adhesion of the ink were performed on the samples coated with the coating liquid for forming the back coat layer of Blend No. 3, namely the samples coated with the coating liquid for forming the back coat layer shown in the above-mentioned Table 1, consisting exclusively of the core-shell type acrylic resin as a base resin, and not containing any crosslinking agent and any surfactant. Consequently, around less than 50% of the ink was removed from the sample immersed in water for one minute, so that the sample was rated as Δ; and 50% or more of the ink was removed from any of the samples immersed in water for two minutes, five minutes, and ten minutes, so that the samples were rated as X.

Meanwhile, the tests of water-resistant adhesion of the ink were performed on the samples coated with the coating liquid for forming the back coat layer of Blend No. 1, namely the samples coated with the coating liquid for forming the back coat layer that was the core-shell type acrylic resin as a base resin containing the polyamide-epichlorohydrin resin as the crosslinking agent and the acetylene glycol-based surfactant. Consequently, the ink was not removed from both of the samples immersed in water for one minute and two minutes, so that the samples were rated as ◯; around less than 50% of the ink was removed from the sample immersed in water for five minutes, so that the sample was rated as Δ; and 50% or more of the ink was removed from the sample immersed in water for ten minutes, so that the sample was rated as X.

The tests of water-resistant adhesion of the ink were performed on the samples coated with the coating liquid for forming the back coat layer of Blend No. 2, namely the samples coated with the coating liquid for forming the back coat layer that was the core-shell type acrylic resin as a base resin containing the oxazoline-based crosslinking agent and the acetylene glycol-based surfactant. Consequently, in the same way as the coating liquid for forming the back coat layer of Blend No. 1, the ink was not removed from both of the samples immersed in water for one minute and two minutes, so that the samples were rated as ◯; around less than 50% of the ink was removed from the sample immersed in water for five minutes, so that the sample was rated as Δ; and 50% or more of the ink was removed from the sample immersed in water for ten minutes, so that the sample was rated as X.

Thus, the water-resistant adhesions of the ink to the samples coated with the coating liquids for forming the back coat layers of Blend Nos. 1 and 2, containing the crosslinking agents, were more satisfactory than the water-resistant adhesions of the ink to the samples coated with the coating liquid for forming the back coat layer of Blend No. 3, consisting exclusively of the core-shell type acrylic resin.

As mentioned above, the adhesions of the ink to the samples coated with the coating liquid for forming the back coat layer of Blend No. 1, containing the polyamide-epichlorohydrin resin as the crosslinking agent, were equivalent to the adhesions of the ink to the samples coated with the coating liquid for forming the back coat layer of Blend No. 2, containing the oxazoline-based crosslinking agent.

### <Measurement Test of Dynamic Surface Tension>

Among the coating liquids for forming the back coat layers in the above-mentioned Table 1, the coating liquids of Blend Nos. 1, 3, 4, and 5 were measured for dynamic surface tension. The dynamic surface tension was measured by the maximum bubble pressure method (bubble pressure method). The dynamic surface tension was specifically measured with the bubble pressure dynamic surface tensiometer BP-2 from KRUSS.

The above-mentioned coating liquids of Blend Nos. 1, 3, 4, and 5 were applied to PET (polyethylene terephthalate) films as substrates having a thickness of 25 μm at 2.5 g/m² in terms of dry weight and dried at 50° C. for one minute, followed by visually checking the surface qualities of the coated surfaces. Specifically, an even and uniform coated surface was rated as ◯, and a coated surface that was nonuniform in thickness and had thin portions was rated as Δ.

The following Table 5 shows the result of measurement of the dynamic surface tension and the results of evaluation of the surface quality.

TABLE 5

| | Dynamic surface | |
|---|---|---|
| | tension mN/m | Surface |
| Blend No. | (50 ms) | quality |
| No. 1 | 35 | ◯ |
| No. 3 | 58 | Δ |
| No. 4 | 51 | ◯ |
| No. 5 | 46 | ◯ |

The coating liquid for forming the back coat layer of Blend No. 4 in the above-mentioned Table 1, namely the coating liquid for forming the back coat layer containing 18 parts of the polyamide-epichlorohydrin resin as the crosslinking agent, and 0.16 parts of the acetylene glycol-based surfactant with an HLB value of 8 as the wetting agent, based on 100 parts of a core-shell type acrylic resin as a base resin in terms of weight ratio in dry condition, had a dynamic surface tension of 51 mN/m at 50 msec. This coating liquid for forming the back coat layer of Blend No. 4 had satisfactory coating suitability. The surface coated therewith was even and uniform, and was rated as satisfactory, ◯.

The coating liquid for forming the back coat layer of Blend No. 5 in the above-mentioned Table 1, namely the coating liquid for forming the back coat layer containing 18 parts of the polyamide-epichlorohydrin resin as the crosslinking agent, and 0.32 parts of the acetylene glycol-based surfactant with an HLB value of 8 as the wetting agent, based on 100 parts of a core-shell type acrylic resin as a base resin in terms of weight ratio in dry condition, had a dynamic surface tension of 46 mN/m at 50 msec.

The coating liquid for forming the back coat layer of Blend No. 1 in the above-mentioned Table 1, namely the coating liquid for forming the back coat layer containing 18 parts of the polyamide-epichlorohydrin resin as the crosslinking agent, 1.3 parts of the acetylene glycol-based surfactant with an HLB value of 13 to 14 as the wetting agent, based on 100 parts of a core-shell type acrylic resin as a base resin in terms of weight ratio in dry condition, had a dynamic surface tension of 35 mN/m at 50 msec.

Both the coating liquids for forming the back coat layers of Blend Nos. 5 and 1, having lower dynamic surface tensions at 50 msec than the dynamic surface tension of the coating liquid for forming the back coat layer of Blend No. 4, 51 mN/m, had satisfactory coating suitability. The surfaces coated therewith were even and uniform, and were rated as satisfactory, ◯.

Meanwhile, the coating liquid for forming the back coat layer of Blend No. 3 in the above-mentioned Table 1, namely the coating liquid for forming the back coat layer consisting exclusively of 100 parts of the core-shell type acrylic resin as a base resin and not containing any crosslinking agent or any wetting agent, had a dynamic surface tension of 58 mN/m at 50 msec, which was higher than the dynamic surface tension, 51 mN/m, of the coating liquid for forming the back coat layer of Blend No. 4. This coating liquid for forming the back coat layer of Blend No. 3 had poor coating suitability. The surface coated therewith had an uneven thickness, had thin portions, and was rated as Δ.

In order to obtain a surface quality having satisfactory coating suitability as mentioned above with a uniform coated surface, the coating liquid for forming the back coat layer preferably has a dynamic surface tension of 51 mN/m or less at 50 msec.

As such, according to the present embodiment, the back coat layer contains the core-shell type acrylic resin and the polyamide-epichlorohydrin resin, and therefore has satisfactory film formability, so that the back coat layer enables to suppress curling even though the substrate is thin. Since the transparent resin film as the substrate can thus be thinned, the amount of the resin material used can be cut for plastic reduction.

Since the polyamide-epichlorohydrin resin is contained as the crosslinking agent for crosslinking the core-shell type acrylic resin, the transparency increases more than the oxazoline-based crosslinking agent.

A thermal recording material including a substrate 2, a thermal recording layer 3, a top coat layer 6, and an intermediate layer 7 shown in FIG. 1 without a back coat layer 5 has high transparency similarly as the thermal recording material described in the above-mentioned Patent Literature 1. Therefore, the thermal recording material 1 of the present embodiment including the back coat layer 5 also has high transparency.

Accordingly, if the thermal recording material 1 of the present embodiment is bonded to a container, for example, as a packaging film, the contents of the container can be visually checked through the film.

In another embodiment of the present invention, the anchor layer may be disposed for enhancing the adhesion between the substrate 2 and the back coat layer 5 in FIG. 1.

Hereinafter, configurations of the present invention and variations thereof will be additionally stated as a summary of the above.

[Additional statement 1]A thermal recording material, wherein a substrate, a thermal recording layer and a protective layer are stacked on one surface of the substrate in this order, and a back coat layer is formed on the other surface of the substrate, wherein the substrate consists of a transparent resin film, and wherein the back coat layer comprises a core-shell type resin and polyamide-epichlorohydrin resin.

[Additional statement 2] The thermal recording material according to additional statement 1, wherein the protective layer comprises a top coat layer and an intermediate layer formed between the top coat layer and the thermal recording layer.

[Additional statement 3] The thermal recording material according to additional statement 2, wherein the intermediate layer comprises a core-shell type resin and a crosslinking agent.

[Additional statement 4] The thermal recording material according to additional statement 3, wherein the crosslinking agent is polyamide-epichlorohydrin resin.

[Additional statement 5] The thermal recording material according to any one of additional statements 1 to 4, wherein the content rate of the core-shell type resin comprised in the back coat layer is 50% by mass or more based on 100% by mass of the back coat layer in terms of dry mass.

[Additional statement 6] The thermal recording material according to any one of additional statements 1 to 5, wherein the content rate of the polyamide-epichlorohydrin resin comprised in the back coat layer is 3% by mass or more based on 100% by mass of the back coat layer in terms of dry mass.

[Additional statement 7] The thermal recording material according to any one of additional statements 3 to 6, wherein the content rate of the core-shell type resin comprised in the intermediate layer is 50% by mass or more based on 100% by mass of the intermediate layer in terms of dry mass.

[Additional statement 8] The thermal recording material according to any one of additional statements 3 to 7, wherein the content rate of the crosslinking agent comprised in the intermediate layer is 3% by mass or more based on 100% by mass of the intermediate layer in terms of dry mass.

[Additional statement 9] The thermal recording material according to additional statements 3 to 8, wherein the back coat layer and the intermediate layer comprise similar core-shell type resins.

[Additional statement 10] The thermal recording material according to additional statement 9, wherein the similar core-shell type resin are core-shell type acrylic-based resins.

[Additional statement 11] The thermal recording material according to any one of additional statements 1 to 10, wherein coating liquid for forming the back coat layer has a dynamic surface tension of 51 mN/m or less at 50 msec.

[Additional statement 12] The thermal recording material according to any one of additional statements 1 to 11, wherein the substrate has a thickness of not less than 10 μm and not more than 50 μm.

### REFERENCE SIGNS LIST

1: thermal recording material
2: substrate
3: thermal recording layer
4: protective layer
5: back coat layer
6: top coat layer
7: intermediate layer

1. A thermal recording material,
wherein a substrate, a thermal recording layer and a protective layer are stacked on one surface of the substrate in this order, and
a back coat layer is formed on the other surface of the substrate,
wherein the substrate consists of a transparent resin film,
wherein the protective layer comprises a top coat layer and an intermediate layer formed between the top coat layer and the thermal recording layer,
wherein the back coat layer comprises a core-shell type resin and polyamide-epichlorohydrin resin, and
wherein the intermediate layer comprises a core-shell type resin and polyamide-epichlorohydrin resin.

2. (canceled)

3. (canceled)

4. The thermal recording material according to claim 1, wherein coating liquid for forming the back coat layer has a dynamic surface tension of 51 mN/m or less at 50 msec.

5. The thermal recording material according to claim 1, wherein the substrate has a thickness of not less than 10 μm and not more than 50 μm.

6. (canceled)

7. (canceled)

8. The thermal recording material according to claim 4, wherein the substrate has a thickness of not less than 10 μm and not more than 50 μm.
